(19) United States
(12) Patent Application Publication
(10) Pub. No.: US 2021/0239839 A1
(43) Pub. Date: Aug. 5, 2021

(54) DEPTH MAPPING SYSTEM AND METHOD THEREFOR

(71) Applicant: Melexis Technologies NV, Tessenderlo (BE)

(72) Inventor: Volodymyr SELIUCHENKO, Nashua, NH (US)

(73) Assignee: Melexis Technologies NV, Tessenderlo (BE)

(21) Appl. No.: 17/161,918

(22) Filed: Jan. 29, 2021

Related U.S. Application Data
(60) Provisional application No. 62/967,710, filed on Jan. 30, 2020.

(51) Int. Cl. G01S 17/894; G01S 17/18

(52) U.S. Cl. CPC G01S 17/894; G01S 17/18

(57) ABSTRACT

A depth mapping system includes a time of flight ranging system including structured and unstructured light sources, an optical sensor unit and a signal processing unit. The system time employs first and second time of flight ranging technique in respect of the optical sensor unit. The first and second time of flight techniques measure respective first and second distance ranges over a first and a second respective field of view. Measurement of the first and second distance ranges are respectively at a first angular resolution and a second angular resolution greater than the first angular resolution. The structured and unstructured light sources respectively operate in respect of the first and second time of flight techniques. First and second regions of the optical sensor unit respectively have the first and second fields of view associated therewith, and the structured source has a greater emission radiant intensity than the unstructured source.

### PRIORITY STATEMENT

The present application hereby claims priority under 35 U.S.C. § 119(e) to U.S. provisional patent application No. 62/967,710 filed Jan. 30, 2020, the entire contents of which are hereby incorporated herein by reference.

### FIELD

The present invention relates to a depth mapping system of the type that, for example, employs light detection and ranging. The present invention also relates to a method of depth mapping, the method being of the type that, for example, employs light detection and ranging.

### BACKGROUND

It is known for mobile robots like, for example robotic vacuum cleaners, to solve Simultaneous Localisation And Mapping (SLAM) navigation problems in order to build a map of the unknown environment and determine their position in the environment. It is possible to employ a high resolution and high range three-dimensional Light Detection And Ranging (LiDAR) sensor to implement SLAM. However, signals from such a sensor comprise a great deal of redundant information in order to support the resolution required to classify and avoid obstacles in the close vicinity to a robot. This same sensor is used to map the periphery of the environment, which requires a longer range than the local classification task mentioned above. This dual requirement of the sensor, namely high resolution and high range, results in a LiDAR system of the robot having to handle a high signal bandwidth and thereby imposes an undesirably high computing power specification on the LiDAR system. Whilst supporting both the resolution and range requirements separately with two separate sensors is possible, such an implementation can lead to unnecessary system cost increases.

To overcome such cost penalties, it is known to provide a number of two-dimensional image sensors to cover a region of interest to be monitored, but such implementations using two-dimensional image sensors have high processing power requirements and are less robust in terms of measurement accuracy when less costly lower processing power is used. Also, the passive stereo imaging depth inference is intrinsically incapable of measuring distance to objects with uniform brightness, for example, a white wall.

Another alternative imaging technique employs ultrasound waves but such an implementation suffers from both an impractically low range and low resolution.

Also, time of flight measurement techniques, which simply employ the underlying operating principle of indirect time of flight measurement, only possess a relatively low measurement range and suffer from multipath errors, a poor range/power trade-off, and are relatively expensive as compared with other known solutions.

US patent publication no. 2018/253856 relates to a near-eye display device that employs multiple light emitters with a single, multi-spectrum imaging sensor to perform both depth sensing and SLAM using first light of a first frequency to generate a depth map and second light of a second frequency to tracks a position and/or orientation of at least a part of a user of the near-eye display device.

### SUMMARY

According to a first aspect of the present invention, there is provided a depth mapping system comprising: a time of flight ranging system comprising: an unstructured light source and a structured light source; an optical sensor unit; and a signal processing unit; wherein the time of flight ranging system is configured to employ a first time of flight ranging technique and a second time of flight ranging technique in respect of the optical sensor unit, the first time of flight ranging technique is configured to measure distance ranges over a first field of view, and the second time of flight ranging technique is configured to measure distance ranges over a second field of view; the measurement of first distance ranges over the first field of view is at a first angular resolution and the measurement of second distance ranges over the second field of view is at a second angular resolution greater than the first angular resolution; the structured light source is configured to operate in respect of the first time of flight ranging technique and the unstructured light source is configured to operate in respect of the second time of flight ranging technique; a first region of the optical sensor unit has the first field of view associated therewith and a second region of the optical sensor unit has the second field of view associated therewith; and the structured light source is configured to emit structured light having a first radiant intensity and the unstructured light source is configured to emit unstructured light having a second radiant intensity, the first radiant intensity being greater than the second radiant intensity.

The first and second regions may overlap at least in part.

The first and second regions may be a substantially identical region of the optical sensor unit and a predetermined portion of the substantially identical region of the optical sensor unit may be employed for detection in respect of the measurement of second distance ranges.

The first time of flight ranging technique may have a first operating distance range associated therewith and the second time of flight ranging technique may have a second operating distance range associated therewith; the first operating distance range may be greater than the second operating distance range.

The first field of view may be laterally broader than the second field of view.

The time of flight ranging system may be configured to map a periphery using the first time of flight ranging technique and may be configured to classify and/or detect a non-peripheral obstacle using the second time of flight ranging technique.

The first time of flight ranging technique may be a direct time of flight ranging technique employing the structured light source.

The second time of flight ranging technique may be direct time of flight ranging technique employing the unstructured light source.

The first time of flight ranging technique may be a direct time of flight ranging technique employing the structured light source and the second time of flight ranging technique may also be a direct time of light ranging technique employing the unstructured light source.

The first time of flight ranging technique may be an indirect time of flight ranging technique employing the structured light source and the second time of flight ranging technique may also be an indirect time of light ranging technique employing the unstructured light source.

The first time of flight ranging technique may be an indirect time of flight ranging technique employing the structured light source and the second time of flight ranging technique may also be a direct time of light ranging technique employing the unstructured light source.

The unstructured light source may be selected so as to provide a uniform illumination beam pattern.

The optical sensor unit may be configured to support both the first and second time of flight ranging techniques.

The optical sensor unit may comprise a plurality of optical sensor elements. The plurality of optical sensor elements may employ a common sensing technique. The plurality of optical sensor elements may comprise a same device structure.

The signal processing unit may be configured to determine, when in use, a location within a room and to detect an obstacle within the room.

The time of flight ranging system may be configured to time multiplex employment of the first time of flight ranging technique and the second time of flight ranging technique. The time of flight ranging system may be configured to alternate employment of the first time of flight ranging technique and the second time of flight ranging technique.

The time of flight ranging system may be configured to illuminate a scene substantially omnidirectionally in respect of the first time of flight ranging technique.

The first field of view may be laterally between about 270 and about 360 degrees. The first field of view may be vertically between about 1 degree and about 90 degrees, for example between about 2 degrees and about 90 degrees.

The time of flight ranging system may comprise reflective, refractive, diffractive and/or holographic optical elements configured to provide the substantially omnidirectional illumination.

The time of flight ranging system may be configured to employ the second time of flight ranging technique to measure in respect of a movement trajectory over a predetermined illumination beam width.

The second field of view may be laterally between about 30 degree and about 90 degrees. The second field of view may be vertically between about 15 degrees and about 50 degrees.

According to a second aspect of the present invention, there is provided a mobile robotic device comprising: a system of locomotion; and the depth mapping system as set forth above in relation to the first aspect of the invention.

The depth mapping system may be a local depth system.

According to a third aspect of the present invention, there is provided a method of depth mapping comprising: employing a first time of flight ranging technique and a second time of flight ranging technique in respect of an optical sensor unit; providing structured light illumination when measuring distance ranges using the first time of flight ranging technique over a first field of view; providing unstructured light illumination when measuring distance ranges using the second time of flight ranging technique over a second field of view; the measurement of first distance ranges over the first field of view is at a first angular resolution and the measurement of second distance ranges over the second field of view is at a second angular resolution greater than the first angular resolution; and directing first reflected light to a first region of the optical sensor unit in respect of the first field of view and directing second reflected light to a second region of the optical sensor unit in respect of the second field of view; wherein the structured light source emits structured light having a first radiant intensity and the unstructured light source emits unstructured light having a second radiant intensity, the first radiant intensity being greater than the second radiant intensity.

According to a fourth aspect of the present invention, there is provided a method of depth mapping comprising: employing a first time of flight ranging technique and a second time of flight ranging technique in respect of an optical sensor unit; providing structured light illumination when measuring distance ranges using the first time of flight ranging technique over a first field of view; providing unstructured light illumination when measuring distance ranges using the second time of flight ranging technique over a second field of view; the measurement of first distance ranges over the first field of view is at a first angular resolution and the measurement of second distance ranges over the second field of view is at a second angular resolution greater than the first angular resolution; and directing first reflected light to a first region of the optical sensor unit in respect of the first field of view and directing second reflected light to a second region of the optical sensor unit in respect of the second field of view; wherein emission of structured light has a first radiant intensity and emission of unstructured light has a second radiant intensity, the first radiant intensity being greater than the second radiant intensity.

It is thus possible to provide a system and method that has a lower processing overhead and is an economic alternative to existing systems and methods. The economic attribute of the system therefore enables the implementation of low-cost mobile robotic applications with high autonomy and reliable navigation. The angular resolution employed for generating the environment map is lower than the angular resolution employed for local obstacle classification and/or detection; it results in a reduction in the required bandwidth over known high resolution systems. The reduced burden of generated data yields the lower processing overhead requirement. The system also therefore has improved energy efficiency. The use of structured light improves the signal to noise ratio of the time of flight ranging technique using the structured light, which also reduces required exposure time of the optical sensor unit and therefore improves robustness of measurements during exposure of a scene to sunlight.

### BRIEF DESCRIPTION OF THE DRAWINGS

At least one embodiment of the invention will now be described, by way of example only, with reference to the accompanying drawings, in which:

FIG. 1 is a schematic diagram of a mobile robot system within a room, the robot system comprising a depth mapping system constituting an embodiment of the invention;

FIG. 2 is a schematic plan view of the depth mapping system of FIG. 1 in greater detail;

FIG. 3 is a schematic side elevation of a light source, sensor and an optical system of the depth mapping system of FIG. 1;

FIG. 4 is a schematic plan view of the sensor of FIG. 3 and an exemplary illumination thereof;

FIG. 5 is a schematic side elevation of the light source, the sensor and an alternative optical system to that of FIG. 3 and constituting another embodiment of the invention; and

FIG. 6 is a flow diagram of a method of performing the depth mapping technique constituting a further embodiment of the invention.

### DETAILED DESCRIPTION OF THE EXAMPLE EMBODIMENTS

Throughout the following description, identical reference numerals will be used to identify like parts.

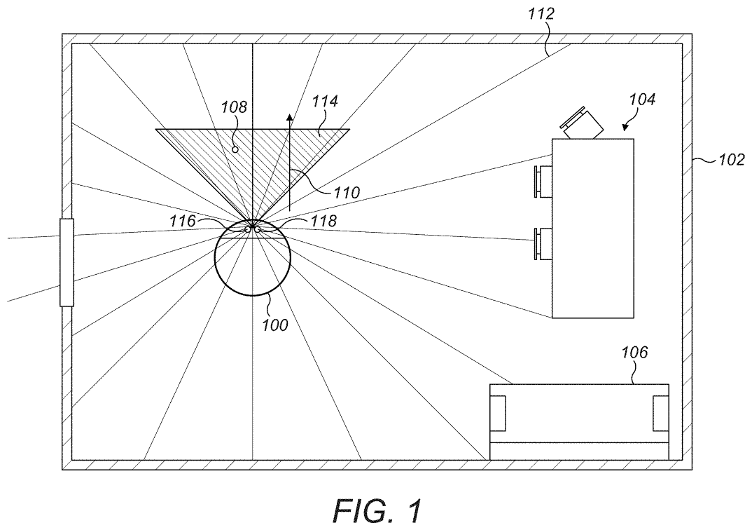

Referring to FIG. 1, a mobile robotic device 100, for example a robotic vacuum cleaner, is located in a room 102. The mobile robotic device 100 comprises, in this example, a system of locomotion to provide the mobility of the mobile robotic device 100. In this example, the room 102 comprises a periphery, for example walls bounding the room 102 and semi-permanent fixtures located in the room 102, for example a table and chairs 104 and a sofa 106. The room 102 also, in this example, comprises a temporary obstacle 108 in the path of the mobile robotic device 100. The skilled person should appreciate that the shape and configuration, and the population of the room 102 with semi-permanent fixtures is purely exemplary and other room configurations and combinations of permanent fixtures is contemplated. Likewise, the temporary obstacle 108 is described for exemplary purposes only and can differ in nature. Also, the number of temporary obstacles, which are non-peripheral in nature, can vary. In this example, the mobile robotic device 100 has a movement trajectory 110, when in motion, and is configured to emit a plurality of substantially omnidirectional beams 112 from a structured light source 116 and a uniform illumination 114, such as a flood illumination, from an unstructured light source 118, having a predetermined illumination beam width. In this regard, it should be appreciated that a structured light source is a source of illumination capable of intentionally generating a predetermined pattern, for example a matrix of dots or an array of stripes, whereas a uniform light source does not provide illumination in this intentional structured manner. In relation to structured illumination, it should also be appreciated that the structure can be provided by a pattern of a plurality of light sources, or a smaller number of light sources, such as a single light source, cooperating with an optical system, such as a combination of suitable optical elements.

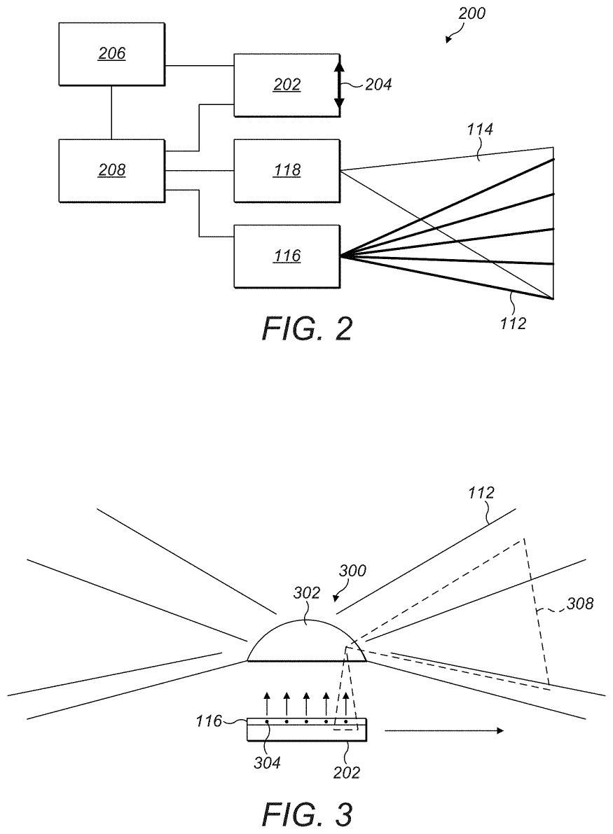

Referring to FIG. 2, the mobile robotic device 100 comprises a depth mapping system that comprises a time of flight ranging system 200. The time of flight ranging system 200 comprises a Time of Flight (ToF) sensor unit 202 including an optical system 204. The ToF sensor unit 202 is operably coupled to a Central Processing Unit (CPU) 206 constituting a signal processing unit. The CPU 206 is operably coupled to a timing signal generator unit 208, the timing signal generator unit 208 being operably coupled to the ToF sensor unit 202, the structured light source 116 and the unstructured light source 118, respectively. In other examples, the timing signal generator unit 208 can be part of the CPU 206 or ToF sensor unit 202. In this example, the TOF sensor unit 202 is configured to generate depth information, which is communicated to the CPU 206, the CPU 206 supporting Simultaneous Localisation And Mapping (SLAM) functionality in the locality of the room 102 for the depth mapping system. In this regard, in this example, the depth mapping system is a local system as opposed to an outdoor system. However, the skilled person will also appreciate that the depth mapping system can also be employed outdoors.

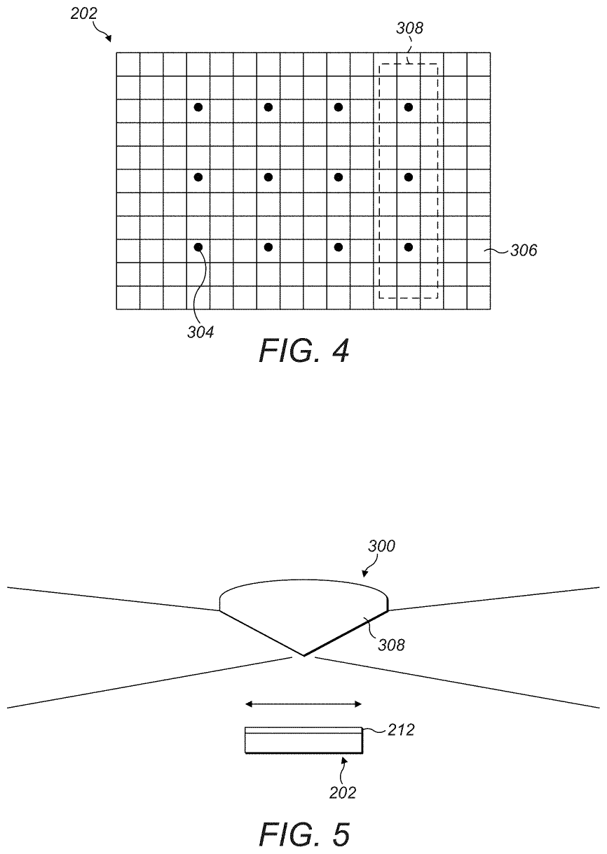

Turning to FIGS. 3 and 4, the optical system 204 comprises one or more optical elements, for example reflective, refractive, diffractive and/or holographic optical elements, to provide the substantially omnidirectional structured illumination 112 and the uniform confined illumination 114. For example, fisheye lens 302, can be disposed in the optical path of the ToF sensor unit 202, the structured light source 116 and the unstructured light source 118. In other examples, mirrors can be disposed in the optical path of both the ToF sensor unit 202 and light sources 116, 118 to adjust field of view and field of illumination. Also, the light sources 116, 118 can be composed of several light emitting elements each having its own optical components. In this regard, the ToF sensor unit 202 and the structured light source 116 are shown schematically as overlaid in FIG. 3 to illustrate that the ToF sensor unit 202, the unstructured light source 118 (not shown) and the structured light source 116 share overlapping fields of view/illumination. The structured light source 116 comprises, in this example, an array of light sources, such as VCSELs 304, to generate a matrix of spaced dots. However, the skilled person will appreciate that the structured illumination can be provided using other illumination techniques, for example any suitable laser source and reflective, refractive, diffractive and/or holographic optics. Referring to FIG. 4, the ToF sensor unit 202 also comprises a plurality of optical sensor elements 306. In relation to the fields of view of the ToF ranging system, the optical system 204 enables the structured light source 212, in this example, to have a first substantially omnidirectional field of illumination and the ToF sensor unit 202 to have a substantially omnidirectional field of view in respect of the illumination provided by the structured light source 116, i.e. the plurality of optical sensor elements 306 has the first field of view. The first field of view can be, for example, laterally between about 270 and about 360 degrees, and vertically between about 2 degrees and about 90 degrees. Additionally, the lens system 204 supports a second, more confined, field of view 308 for detection of local obstacles, and a corresponding field of illumination by the uniform, unstructured, light 114 emitted by the unstructured light source 118 of the ToF sensor unit 202. The second field of view 308 overlies only a subset of the plurality of optical sensor elements 306 as the second field of view 308 is smaller than the first field of view, i.e. the subset of the plurality of optical sensor elements 306 has the second field of view 308. In this regard, the second field of view 308 can be laterally between about 30 degree and about 90 degrees, and vertically between about 15 degrees and about 50 degrees. The first field of view is therefore, in this example, laterally broader than the second field of view 308.

As the structured light source 116 is a plurality of narrow beams that are projected on the TOF sensor unit 202 as an array of dots 304, measurement over the first field of view using the structured light source is at first angular resolution, and measurement over the second field of view 308 using the unstructured light source is at a second angular resolution, the angular resolution of the second measurement is greater than the angular resolution of the first measurement, i.e. the ability to resolve neighbouring reflecting objects within the second field of view 308 is greater than the ability to resolve neighbouring objects within the first field of view.

Referring to FIG. 5, in another example, instead of the optical system 300 comprising the fisheye lens 302, the optical system 300 comprises a conical lens 308 to provide the first and second fields of view and illumination. The skilled person will appreciate that, in other examples, other optical components can additionally or alternatively be used as mentioned above.

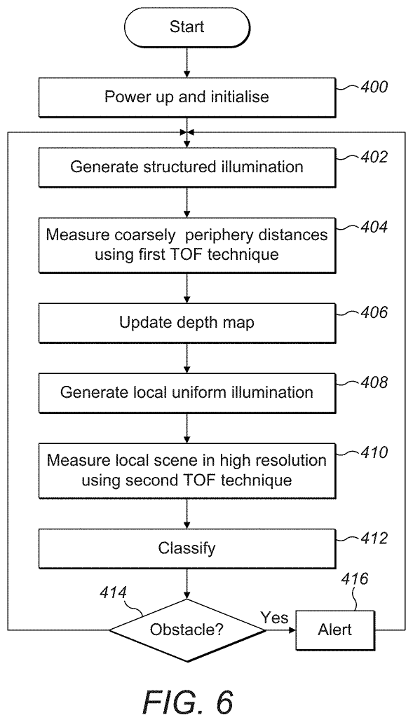

In operation (FIG. 6), the mobile robotic device 100 is placed in the room 200 and powered up (Step 400). Following an initialisation procedure (Step 400), the time of flight ranging system implements a SLAM algorithm, which maps the room 102 including the periphery of the room 102 as defined by the walls thereof, but also the semi-permanent fixtures 104, 106 in the room 102. The time of flight ranging system also detects local obstacles in the path of the mobile robotic device 100 following a movement trajectory 110 (FIG. 1). In this regard, the first field of view supports mapping of the periphery of the room 102 and the semi-permanent fixtures 104, 106, whereas the second field of view 308 supports classification and/or detection of local obstacles.

In this example, the time of flight ranging system 200 is configured to support a first time of flight ranging technique and a second time of flight ranging technique. In this example, the first time of flight ranging technique employs structured illumination 112 and is used to map the room 102 and the second time of flight ranging technique employs uniform, unstructured, illumination 114 and is used to detect local objects. The structured illumination 112 generated by the structured light source 116 has a first radiant intensity and the unstructured illumination 114 generated by the unstructured light source 118 has a second radiant intensity. In this example, the first radiant intensity is greater than the second radiant intensity. For the avoidance of doubt, in this example, the first and second radiant intensities are measures of power per steradian. Furthermore, the first time of flight ranging technique has a first distance measurement range associated therewith and the second time of flight ranging technique has a second distance measurement range, the first operating distance range being greater than the second operating distance range.

The first time of flight ranging technique is, in this example, any time of flight technique that can detect reflections of structured light in a scene. The first time of flight ranging technique can therefore be an indirect time of flight ranging technique or a direct time of flight ranging technique. For example, the technique as described in co-pending European patent application no. 18165668.7 filed on 4 Apr. 2018, the content of which are incorporated herein by reference in its entirety, can be employed. For completeness, this technique employs pulsed illumination to illuminate the scene, in the context of the present example, using the structured light source 116, and ToF sensor unit 202 comprises light-detecting photonic mixers having a time-shifted Pseudorandom Binary signal applied thereto. A time domain light echo signal received by the ToF sensor unit 202 as a result of reflection of an illuminating light pulse signal by an object in the scene can then be reconstructed by frequency domain analysis and a distance measurement can then be made by locating the light echo pulses received relative to the in the illuminating light pulse signal. In this regard, the ToF sensor unit 202 is, in this example, an iToF sensor unit that employs photonic mixer cells, which are suited to this direct ToF ranging technique, but also capable of supporting measurements made using indirect ToF ranging techniques. As such, it should be appreciated that the ToF sensor unit 202 supports both families of measurement technique, namely direct and indirect ToF. In some examples, the plurality of optical sensor elements 306 can employ a same common sensing technique. The plurality of optical sensor elements 306 can be of identical device structure and serve to provide detection for both the first and second time of flight ranging techniques. For example, the ToF sensor unit 202 can comprise a plurality of identical photodetectors, such as a plurality of identical photodetector elements combined with respective photonic mixer cells.

In another example, a conventional indirect time of flight ranging technique can be employed with a modulation frequency low enough for the non-ambiguity range thereof to be higher than a maximum measurable distance. Alternatively, known methods for non-ambiguity range extension, for example multiple frequency illumination, or light coding can be used as the first time of flight measurement technique.

The second time of flight ranging technique can be any suitable time of flight ranging technique that can be implemented with a uniform unstructured light source, for example a direct time of flight ranging technique or an indirect time of flight ranging technique. In this example, the technique as described in co-pending European patent application no. 18165668.7 mentioned above is also employed, but in relation to the second field of view 308. However, the skilled person should appreciate that other direct time of flight ranging techniques can be employed. Similarly, using the uniform light source of the ToF sensor unit 202, any indirect time of flight technique, for example, a technique that estimates a distance from a phase shift between a reference signal applied to a photonic mixer and the impinging light signal, can be employed.

In other examples, the amplitude signal reflections of the light emitted by either of the light sources 116, 118, in respect of either ToF ranging technique can be captured by the ToF module 202 and used for the purposes of object classification and/or detection. The ToF module 202 can also be operated as a passive image sensor with the light sources 116, 118 inactive providing information used for the purposes of object classification and/or detection.

Referring back to FIG. 6, the CPU 206 instructs the ToF sensor unit 202 to illuminate the scene (Step 402), in this example the room 102, using the structured light source 116 with the plurality of substantially omnidirectional beams 112, and the reflected light is measured in accordance with the first time of flight ranging technique described above for measuring ranges to the periphery of the room 102 and/or the semi-permanent fixtures 104, 106. In this example, reflected light originating from the structured light source 116 illuminates a first region of the ToF sensor unit 202 corresponding to the first field of view in respect of which measurements are made using the first time of flight ranging technique, resulting in a coarse measurement (Step 404) of the periphery of the room 102 and/or the semi-permanent fixtures 104, 106, but the angular resolution is sufficient to map the room 102. The CPU 206 maintains a depth map (not shown), recording (Step 406) the periphery of the room 102 and the locations within the room of the semi-permanent fixtures 104, 106, relative to the time of flight ranging system.

In this example, thereafter, the CPU 206 in cooperation with the timing signal generator unit 208 activates the uniform light source 118 to illuminate (Step 408) a local region in the path of the movement trajectory 110 of the mobile robotic device 100 in order to detect obstacles. In this regard, the ToF sensor unit 202 in cooperation with the timing signal generator unit 208 is instructed to employ the second time of flight ranging technique mentioned above to measure reflections generated by the scene and received by the ToF sensor unit 202 via the optical system 204. In this regard, the reflected light originating from the unstructured light source 118 illuminates a second region of the ToF sensor unit 202 corresponding to the second field of view in respect of which measurements are made using the second time of flight ranging technique. In this example, the first and second regions of the ToF sensor unit 202 overlap at least in part.

In this example, the ToF sensor unit 202 uses the measurement of timing of reflections from any obstacles 108 in the room 102 in order to detect any such obstacles 108. In this respect, the local scene is measured (Step 410) and the measurements made in the path of the mobile robotic device 100 can be analysed in order to classify (Step 412) the nature of any non-peripheral obstacle detected using an artificial neural network supported by the CPU 206, in the event that classification is required. In the event that the CPU 206 determines (Step 414) that an obstacle has been detected, the CPU 206 generates (Step 416) an alert for subsequent handling by the functionality of the mobile robotic device 100, for example to make an evasive manoeuvre.

Thereafter, the above procedure of mapping the room followed by localised object detection as described above (Steps 402 to 416) is repeated until such a facility is no longer required, for example when the mobile robotic device 100 is powered down or enters a sleep mode. As can be seen, the use of the first and second time of flight ranging techniques for mapping of the environment and the object detection are time multiplexed, for example alternated as in this example.

The skilled person should appreciate that the above-described implementations are merely examples of the various implementations that are conceivable within the scope of the appended claims. Indeed, it should be appreciated that although the above examples have been described in the context of a robotic vacuum cleaner, other mobile apparatus, vehicles and systems are contemplated, for example drones, other mobile robots, Autonomous Guided Vehicles (AGVs), delivery robots, and vehicles, such as autonomous vehicles.

In the above examples, the first and second regions of the optical sensor unit 202 overlap, at least in part. However, in another example, the first and second fields of view can correspond to substantially an identical region of the optical sensor unit 202, i.e. the first and second regions of the optical sensor unit 202 defined by the first and second fields of view are substantially identical. In this regard, where the fields of view are substantially identical, a predetermined portion of the substantially identical region of the optical sensor unit 202 can be employed for detection using the second time of flight ranging technique over a measurement of distance range thereof in order to achieve the detection in respect of the local region in the path of the movement trajectory 110.

The above examples have been described in the context of time multiplexing the respective illuminations by the structured and unstructured light sources 116, 118, for example alternating illumination by the structured and unstructured light sources 116, 118. However, it should be appreciated that in some examples, the structured and unstructured light sources 116, 118 can be configured to illuminate simultaneously the scene, for example the room 102. The illumination by the structured light source 116 and the unstructured light source 118 can, for example, be in respect of the first field of illumination and the second field of illumination, respectively, or a common field of illumination. In such examples, the first time of flight ranging technique and the second time of flight ranging technique can employ a measurement principle common to both the first and second time of flight ranging techniques, for example an indirect time of flight ranging technique. Additionally or alternatively, the first time of flight ranging technique and the second time of flight ranging technique can be employed in respect of the first field of view and the second field of view, respectively, or they can be in respect of a common field of view and different sets of optical sensor elements can subsequently be selected for measurement in respect of the different fields of view.

What is claimed is:

1. A depth mapping system comprising:
a time of flight ranging system comprising:
an unstructured light source and a structured light source;
an optical sensor unit; and
a signal processing unit; wherein
the time of flight ranging system is configured to employ a first time of flight ranging technique and a second time of flight ranging technique in respect of the optical sensor unit, the first time of flight ranging technique is configured to measure distance ranges over a first field of view, and the second time of flight ranging technique is configured to measure distance ranges over a second field of view;
the measurement of first distance ranges over the first field of view is at a first angular resolution and the measurement of second distance ranges over the second field of view is at a second angular resolution greater than the first angular resolution;
the structured light source is configured to operate in respect of the first time of flight ranging technique and the unstructured light source is configured to operate in respect of the second time of flight ranging technique;
a first region of the optical sensor unit has the first field of view associated therewith and a second region of the optical sensor unit has the second field of view associated therewith; and
the structured light source is configured to emit structured light having a first radiant intensity and the unstructured light source is configured to emit unstructured light having a second radiant intensity, the first radiant intensity being greater than the second radiant intensity.

2. The system according to claim 1, wherein the first time of flight ranging technique has a first operating distance range associated therewith and the second time of flight ranging technique has a second operating distance range associated therewith, the first operating distance range being greater than the second operating distance range.

3. The system according to claim 1, wherein the first field of view is laterally broader than the second field of view.

4. The system according to claim 1, wherein the time of flight ranging system is configured to map a periphery using the first time of flight ranging technique and is configured to classify and/or detect a non-peripheral obstacle using the second time of flight ranging technique.

5. The system according to claim 1, wherein
the first time of flight ranging technique is a direct time of flight ranging technique employing the structured light source.

6. The system according to claim 5, wherein the second time of flight ranging technique is direct time of flight ranging technique employing the unstructured light source.

7. The system according to claim 1, wherein the optical sensor unit is configured to support both the first and second time of flight ranging techniques.

8. The system according to claim 7, wherein the optical sensor unit comprises a plurality of optical sensor elements.

9. The system according to claim 8, wherein the plurality of optical sensor elements employs a common sensing technique.

10. The system according to claim 8, wherein the plurality of optical sensor elements comprises a same device structure.

11. The system according to claim 1, wherein the first and second regions overlap at least in part.

12. The system according to claim 1, wherein
the signal processing unit is configured to determine, when in use, a location within a room and to detect an obstacle within the room.

13. The system according to claim 1, wherein the time of flight ranging system is configured to time multiplex employment of the first time of flight ranging technique and the second time of flight ranging technique.

14. The system according to claim 13, wherein the time of flight ranging system is configured to alternate employment of the first time of flight ranging technique and the second time of flight ranging technique.

15. The system according to claim 1, wherein the time of flight ranging system is configured to illuminate a scene substantially omnidirectionally in respect of the first time of flight ranging technique.

16. The system according to claim 10, wherein the time of flight ranging system comprises reflective, refractive, diffractive and/or holographic optical elements configured to provide the substantially omnidirectional illumination.

17. The system according to claim 1, wherein the time of flight ranging system is configured to employ the second time of flight ranging technique to measure in respect of a movement trajectory over a predetermined illumination beam width.

18. A mobile robotic device comprising:
a system of locomotion; and
the depth mapping system according to claim 1.

19. The mobile robotic device according to claim 18, wherein the depth mapping system is a local depth system.

20. A method of depth mapping comprising:
employing a first time of flight ranging technique and a second time of flight ranging technique in respect of an optical sensor unit;
providing structured light illumination when measuring distance ranges using the first time of flight ranging technique over a first field of view;
providing unstructured light illumination when measuring distance ranges using the second time of flight ranging technique over a second field of view;
the measurement of first distance ranges over the first field of view is at a first angular resolution and the measurement of second distance ranges over the second field of view is at a second angular resolution greater than the first angular resolution; and
directing first reflected light to a first region of the optical sensor unit in respect of the first field of view and directing second reflected light to a second region of the optical sensor unit in respect of the second field of view; wherein
the structured light source emits structured light having a first radiant intensity and the unstructured light source emits unstructured light having a second radiant intensity, the first radiant intensity being greater than the second radiant intensity.
